(19) United States
(12) Patent Application Publication
(10) Pub. No.: US 2018/0146624 A1
(43) Pub. Date: May 31, 2018

(54) DETERMINING INTRA-FIELD YIELD VARIATION DATA BASED ON SOIL CHARACTERISTICS DATA AND SATELLITE IMAGES

(71) Applicant: THE CLIMATE CORPORATION, San Francisco, CA (US)

(72) Inventors: YE CHEN, Pleasanton, CA (US); YING XU, Boston, MA (US)

(21) Appl. No.: 15/362,327

(22) Filed: Nov. 28, 2016

(51) Int. Cl. A01G 1/00; A01G 7/00; A01G 25/00; G05B 13/02

(52) U.S. Cl. CPC A01G 1/001; G05B 13/0265; A01G 25/00; A01G 7/00

(57) ABSTRACT

In an embodiment, a data processing method comprises receiving permanent properties data for a plurality of agricultural sub-fields of an agricultural field; determining whether at least one data item is missing for any sub-field of the plurality of agricultural sub-fields in the permanent properties data, and if so, generating additional properties data for the plurality of agricultural sub-fields; generating preprocessed permanent properties data by merging the permanent properties data with the additional properties data; generating filtered permanent properties data by removing, from the preprocessed permanent properties data, a set of preprocessed permanent properties records corresponding to a subset of the plurality of agricultural sub-fields in which two or more crops were grown in the same year; applying a regression operator to the filtered permanent properties data to determine a plurality of intra-field variations values that represent intra-field variations in predicted yield of crop harvested from the plurality of agricultural sub-fields.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2016 The Climate Corporation.

### FIELD OF THE DISCLOSURE

The technical field of the present disclosure includes computer systems useful in agriculture. The disclosure is also in the technical field of computer systems that are programmed or configured to generate, based on properties of an agricultural field, computer implemented predictions of relative yield performance of crops.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Crop yield productivity in an agricultural field usually varies from one part of the field to another. Therefore, ignoring variations in crop yield and instead managing the field uniformly often results in inefficient and unproductive land use. There is a need for obtaining data that can be used in better management of fields that have variable yield.

Some methods for managing an agricultural field include site-specific approaches that allow managing each part of the field individually. This type of management of the field often leads to a more abundant crop harvest and more efficient use of equipment, fertilizer or other amendments. Therefore, understanding the field-specific variations and characteristics and developing a site-specific management system are often a prerequisite to increasing efficiency in using other technologies.

### SUMMARY

The appended claims may serve as a summary of the disclosure.

### BRIEF DESCRIPTION OF THE DRAWINGS

In the drawings:

FIG. 1 illustrates an example computer system that is configured to perform the functions described herein, shown in a field environment with other apparatus with which the system may interoperate.

FIG. 2 illustrates two views of an example logical organization of sets of instructions in main memory when an example mobile application is loaded for execution.

FIG. 3 illustrates a programmed process by which the agricultural intelligence computer system generates one or more preconfigured agronomic models using agronomic data provided by one or more data sources.

FIG. 4 is a block diagram that illustrates a computer system 400 upon which an embodiment of the invention may be implemented.

FIG. 5 depicts an example embodiment of a timeline view for data entry.

FIG. 6 depicts an example embodiment of a spreadsheet view for data entry.

FIG. 7 is a flow diagram that depicts an example method or algorithm for determining intra-field yield variations based on persistent properties data for an agricultural field.

FIG. 8 depicts an example embodiment of filtering persistent properties data.

FIG. 9 depicts an example embodiment of preprocessing persistent properties data.

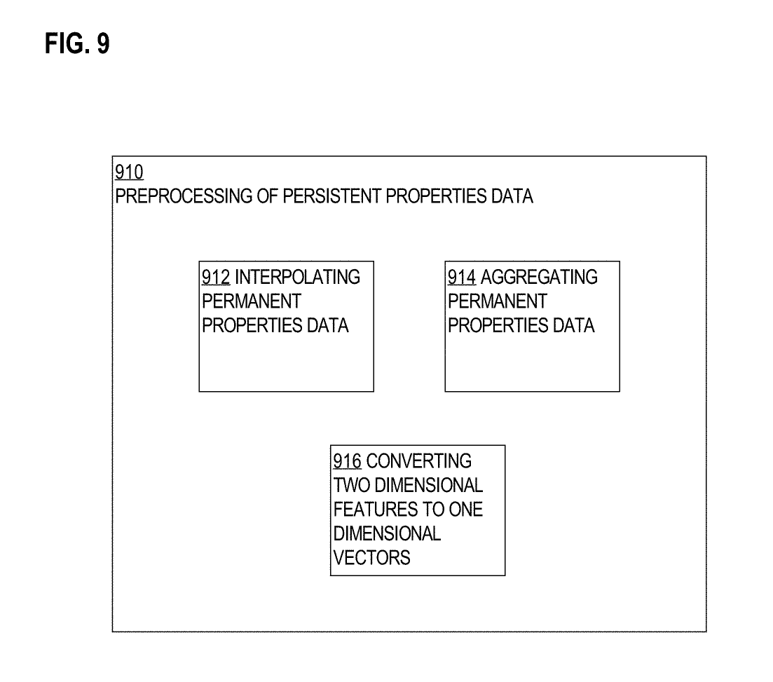

### DETAILED DESCRIPTION

In the following description, for the purposes of explanation, numerous specific details are set forth in order to provide a thorough understanding of the present disclosure. It will be apparent, however, that embodiments may be practiced without these specific details. In other instances, well-known structures and devices are shown in block diagram form in order to avoid unnecessarily obscuring the present disclosure. Embodiments are disclosed in sections according to the following outline:
1. GENERAL OVERVIEW
   1.1 INTRODUCTION
   1.2 OVERVIEW
2. EXAMPLE AGRICULTURAL INTELLIGENCE COMPUTER SYSTEM
   2.1 STRUCTURAL OVERVIEW
   2.2 APPLICATION PROGRAM OVERVIEW
   2.3 DATA INGEST TO THE COMPUTER SYSTEM
   2.4 PROCESS OVERVIEW—AGRONOMIC MODEL TRAINING
   2.5 IMPLEMENTATION EXAMPLE—HARDWARE OVERVIEW
3. PERSISTENT PROPERTIES OF AN AGRICULTURAL FIELD
   3.1 SOIL ATTRIBUTES DATA
   3.2 TOPOGRAPHICAL FEATURES DATA
4. PREPROCESSING AND FILTERING OF PERSISTENT PROPERTIES DATA
   4.1 FILTERING OF PERSISTENT PROPERTIES DATA
   4.2 PREPROCESSING OF PERSISTENT PROPERTIES DATA
      4.2.1 SPATIAL INTERPOLATION OF SOIL ATTRIBUTES DATA
      4.2.2 CORRELATING PERSISTENT FEATURES
5. DETERMINING INTRA-FIELD YIELD VARIATIONS BASED ON PROPERTIES OF AN AGRICULTURAL FIELD
   5.1 DETERMINING YIELD VARIATIONS USING LASSO APPROACH
   5.2 DETERMINING YIELD VARIATIONS USING RANDOM FOREST APPROACH
6. BENEFITS AND EXTENSIONS

### 1. General Overview

1.1 Introduction

Certain properties of an agricultural field are referred to as persistent properties or permanent properties. The persistent properties may include topological properties of a field, geographical characteristics, soil characteristics, elevation characteristics, and others. They may be determined or obtained based on soil survey maps, soil sample data, topographical surveys, bare soil maps, and/or in-season satellite images.

Persistent properties of an agricultural field usually vary within the field from one part of the field to another, and therefore the properties' variations may be used to identify sub-fields within the field. Each sub-field in the field may have at least one persistent property that distinguishes that sub-field from at least other sub-fields in the field.

Knowing persistent properties of sub-fields of an agricultural field may be used in developing agricultural practices that are customized specifically for each individual sub-field. Customizing the practices is desirable because can lead to increased harvest and efficiency in use of resources.

Information about yield performance for each individual sub-field provides a valuable insight to a grower. However, relative yield performance data, as opposite to the absolute yield performance data, is even more valuable to a grower because it may help the grower to improve his customized plan for cultivating the field.

Additional benefits of using relative yield performance data determined for sub-fields, as opposite to using absolute yield performance data, is that it reveals reoccurring spatial yield patterns within a field better than the absolute data. Furthermore, the relative yield performance data allows using yield records of different crops without limitations or constraints. Moreover, the relative yield performance data is more resilient to outliers which are commonly present in the absolute yield data. In addition, the relative yield performance data is easy to obtain. For example, relative yield performance data may be obtained by converting absolute yield performance data to relative yield performance data using the normal quantile transformation (NQT).

In an embodiment, relative yield performance data for agricultural sub-fields, also referred to as intra-field yield variations data, is determined based on absolute yield performance data, which in turn is determined based on topological, geographical and other persistent characteristics of the field and the soil, and not based on historical yield performance data.

In an embodiment, information about intra-field yield variations across sub-fields of an agricultural field is used to automatically control a computer system that manages certain agronomic practices such as seeding, irrigation, nitrogen application, and/or harvesting. For example, the intra-field yield variations across the sub-fields may be used to determine recommendations for fertilizing each individual sub-field in a way that is appropriate for a physical matter structure of the individual sub-field.

### 1.2 Overview

In an embodiment, an approach for determining intra-field yield variations based on soil characteristics and satellite imagery is presented. The approach may be implemented in any computing device. For example, the approach may be implemented in a computer server, a workstation, a laptop, a smartphone, or any other electronic device configured to receive, transmit, or process electronic data.

In an embodiment, an approach comprises receiving permanent properties data for a plurality of agricultural sub-fields of an agricultural field. Permanent properties data for the sub-fields may comprise soil property data, soil survey maps, topographical properties data, bare soil maps, and/or satellite images. Soil property data may comprise soil measurement data. Topographical properties data may comprise elevation data and elevation associated properties data.

The approach may also include determining whether at least one data item is missing for any of the sub-fields in the permanent properties data. In response to determining that at least one data item is missing in the permanent properties data, a value for the missing data item may be generated by interpolating and/or aggregating two or more data records in the permanent properties data. The resulting permanent properties data is also referred to a preprocessed permanent properties data.

In an embodiment, based on, at least in part, the preprocessed permanent properties data, filtered permanent properties data is generated. The filtered permanent properties data may be generated by removing, from the preprocessed permanent properties data, certain data records. Such records may include the records for the sub-fields on which two or more crops were grown in the same year, the records that are duplicative of each other, the outliers, and the like.

In an embodiment, a regression operator is applied to the filtered permanent properties data to determine a plurality of intra-field variations values. Intra-field variations values represent variations in predicted yield of crop harvested from the sub-fields. The intra-field variations values may be stored in the computer memory.

In an embodiment, applying a regression operator includes applying a least absolute shrinkage and selection operator (LASSO) to the filtered permanent properties data to determine the plurality of intra-field variations values.

In an embodiment, applying a regression operator includes applying a random forest (RF) operator to the filtered permanent properties data to determine the plurality of intra-field variations values.

In an embodiment, based on, at least in part, the plurality of intra-field variations values, a plurality of yield patterns of the predicted yield of crop harvested from the sub-fields is determined and stored in the computer memory.

In an embodiment, intra-field variations values are used to automatically control a computer control system to manage one or more of: seeding, irrigation, nitrogen application, or harvesting.

### 2. Example Agricultural Intelligence Computer System

2.1 Structural Overview

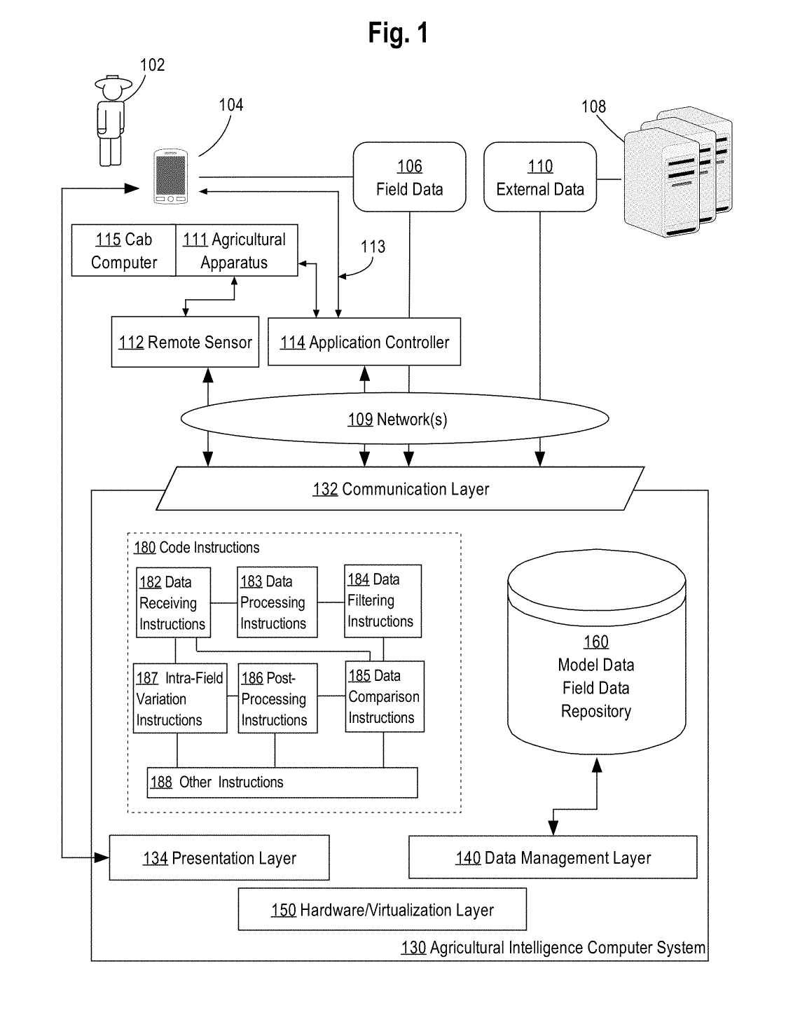

FIG. 1 illustrates an example computer system that is configured to perform the functions described herein, shown in a field environment with other apparatus with which the system may interoperate. In one embodiment, a user 102 owns, operates or possesses a field manager computing device 104 in a field location or associated with a field location such as a field intended for agricultural activities or a management location for one or more agricultural fields. The field manager computer device 104 is programmed or configured to provide field data 106 to an agricultural intelligence computer system 130 via one or more networks 109.

Examples of field data 106 include (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) pesticide data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), and (k) soil, seed, crop phenology, pest and disease reporting, and predictions sources and databases.

A data server computer 108 is communicatively coupled to agricultural intelligence computer system 130 and is programmed or configured to send external data 110 to agricultural intelligence computer system 130 via the network(s) 109. The external data server computer 108 may be owned or operated by the same legal person or entity as the agricultural intelligence computer system 130, or by a different person or entity such as a government agency, non-governmental organization (NGO), and/or a private data service provider. Examples of external data include weather data, imagery data, soil data, or statistical data relating to crop yields, among others. External data 110 may consist of the same type of information as field data 106. In some embodiments, the external data 110 is provided by an external data server 108 owned by the same entity that owns and/or operates the agricultural intelligence computer system 130. For example, the agricultural intelligence computer system 130 may include a data server focused exclusively on a type of data that might otherwise be obtained from third party sources, such as weather data. In some embodiments, an external data server 108 may actually be incorporated within the system 130.

An agricultural apparatus 111 may have one or more remote sensors 112 fixed thereon, which sensors are communicatively coupled either directly or indirectly via agricultural apparatus 111 to the agricultural intelligence computer system 130 and are programmed or configured to send sensor data to agricultural intelligence computer system 130. Examples of agricultural apparatus 111 include tractors, combines, harvesters, planters, trucks, fertilizer equipment, unmanned aerial vehicles, and any other item of physical machinery or hardware, typically mobile machinery, and which may be used in tasks associated with agriculture. In some embodiments, a single unit of apparatus 111 may comprise a plurality of sensors 112 that are coupled locally in a network on the apparatus; controller area network (CAN) is example of such a network that can be installed in combines or harvesters. Application controller 114 is communicatively coupled to agricultural intelligence computer system 130 via the network(s) 109 and is programmed or configured to receive one or more scripts to control an operating parameter of an agricultural vehicle or implement from the agricultural intelligence computer system 130. For instance, a controller area network (CAN) bus interface may be used to enable communications from the agricultural intelligence computer system 130 to the agricultural apparatus 111, such as how the CLIMATE FIELDVIEW DRIVE, available from The Climate Corporation, San Francisco, Calif., is used. Sensor data may consist of the same type of information as field data 106. In some embodiments, remote sensors 112 may not be fixed to an agricultural apparatus 111 but may be remotely located in the field and may communicate with network 109.

The apparatus 111 may comprise a cab computer 115 that is programmed with a cab application, which may comprise a version or variant of the mobile application for device 104 that is further described in other sections herein. In an embodiment, cab computer 115 comprises a compact computer, often a tablet-sized computer or smartphone, with a graphical screen display, such as a color display, that is mounted within an operator's cab of the apparatus 111. Cab computer 115 may implement some or all of the operations and functions that are described further herein for the mobile computer device 104.

The network(s) 109 broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. The sensors 112, controller 114, external data server computer 108, and other elements of the system each comprise an interface compatible with the network(s) 109 and are programmed or configured to use standardized protocols for communication across the networks such as TCP/IP, Bluetooth, CAN protocol and higher-layer protocols such as HTTP, TLS, and the like.

Agricultural intelligence computer system 130 is programmed or configured to receive field data 106 from field manager computing device 104, external data 110 from external data server computer 108, and sensor data from remote sensor 112. Agricultural intelligence computer system 130 may be further configured to host, use or execute one or more computer programs, other software elements, digitally programmed logic such as FPGAs or ASICs, or any combination thereof to perform translation and storage of data values, construction of digital models of one or more crops on one or more fields, generation of recommendations and notifications, and generation and sending of scripts to application controller 114, in the manner described further in other sections of this disclosure.

In an embodiment, agricultural intelligence computer system 130 is programmed with or comprises a communication layer 132, presentation layer 134, data management layer 140, hardware/virtualization layer 150, and model and field data repository 160. “Layer,” in this context, refers to any combination of electronic digital interface circuits, microcontrollers, firmware such as drivers, and/or computer programs or other software elements.

Communication layer 132 may be programmed or configured to perform input/output interfacing functions including sending requests to field manager computing device 104, external data server computer 108, and remote sensor 112 for field data, external data, and sensor data respectively. Communication layer 132 may be programmed or configured to send the received data to model and field data repository 160 to be stored as field data 106.

Presentation layer 134 may be programmed or configured to generate a graphical user interface (GUI) to be displayed on field manager computing device 104, cab computer 115 or other computers that are coupled to the system 130 through the network 109. The GUI may comprise controls for inputting data to be sent to agricultural intelligence computer system 130, generating requests for models and/or recommendations, and/or displaying recommendations, notifications, models, and other field data.

Data management layer 140 may be programmed or configured to manage read operations and write operations involving the repository 160 and other functional elements of the system, including queries and result sets communicated between the functional elements of the system and the repository. Examples of data management layer 140 include JDBC, SQL server interface code, and/or HADOOP interface code, among others. Repository 160 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data 106 is not provided directly to the agricultural intelligence computer system via one or more agricultural machines or agricultural machine devices that interacts with the agricultural intelligence computer system, the user may be prompted via one or more user interfaces on the user device (served by the agricultural intelligence computer system) to input such information. In an example embodiment, the user may specify identification data by accessing a map on the user device (served by the agricultural intelligence computer system) and selecting specific CLUs that have been graphically shown on the map. In an alternative embodiment, the user 102 may specify identification data by accessing a map on the user device (served by the agricultural intelligence computer system 130) and drawing boundaries of the field over the map. Such CLU selection or map drawings represent geographic identifiers. In alternative embodiments, the user may specify identification data by accessing field identification data (provided as shape files or in a similar format) from the U. S. Department of Agriculture Farm Service Agency or other source via the user device and providing such field identification data to the agricultural intelligence computer system.

In an example embodiment, the agricultural intelligence computer system 130 is programmed to generate and cause displaying a graphical user interface comprising a data manager for data input. After one or more fields have been identified using the methods described above, the data manager may provide one or more graphical user interface widgets which when selected can identify changes to the field, soil, crops, tillage, or nutrient practices. The data manager may include a timeline view, a spreadsheet view, and/or one or more editable programs.

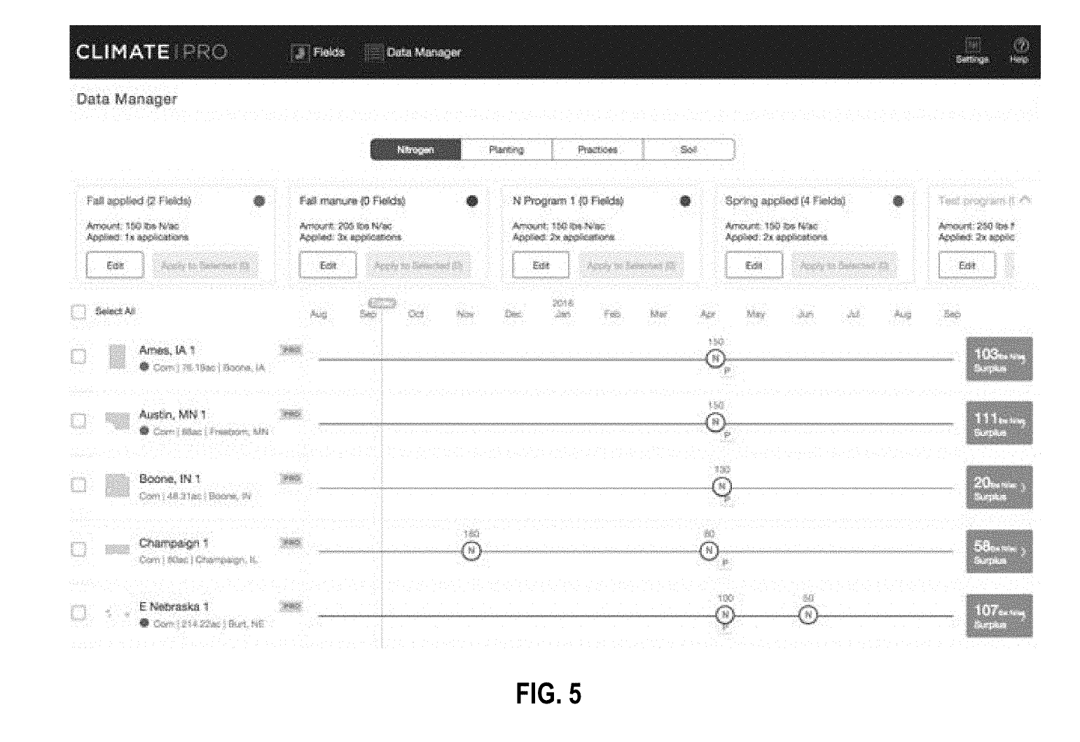

FIG. 5 depicts an example embodiment of a timeline view for data entry. Using the display depicted in FIG. 5, a user computer can input a selection of a particular field and a particular date for the addition of event. Events depicted at the top of the timeline may include Nitrogen, Planting, Practices, and Soil. To add a nitrogen application event, a user computer may provide input to select the nitrogen tab. The user computer may then select a location on the timeline for a particular field in order to indicate an application of nitrogen on the selected field. In response to receiving a selection of a location on the timeline for a particular field, the data manager may display a data entry overlay, allowing the user computer to input data pertaining to nitrogen applications, planting procedures, soil application, tillage procedures, irrigation practices, or other information relating to the particular field. For example, if a user computer selects a portion of the timeline and indicates an application of nitrogen, then the data entry overlay may include fields for inputting an amount of nitrogen applied, a date of application, a type of fertilizer used, and any other information related to the application of nitrogen.

In an embodiment, the data manager provides an interface for creating one or more programs. “Program,” in this context, refers to a set of data pertaining to nitrogen applications, planting procedures, soil application, tillage procedures, irrigation practices, or other information that may be related to one or more fields, and that can be stored in digital data storage for reuse as a set in other operations. After a program has been created, it may be conceptually applied to one or more fields and references to the program may be stored in digital storage in association with data identifying the fields. Thus, instead of manually entering identical data relating to the same nitrogen applications for multiple different fields, a user computer may create a program that indicates a particular application of nitrogen and then apply the program to multiple different fields. For example, in the timeline view of FIG. 5, the top two timelines have the “Fall applied” program selected, which includes an application of 150 lbs N/ac in early April. The data manager may provide an interface for editing a program. In an embodiment, when a particular program is edited, each field that has selected the particular program is edited. For example, in FIG. 5, if the “Fall applied” program is edited to reduce the application of nitrogen to 130 lbs N/ac, the top two fields may be updated with a reduced application of nitrogen based on the edited program.

In an embodiment, in response to receiving edits to a field that has a program selected, the data manager removes the correspondence of the field to the selected program. For example, if a nitrogen application is added to the top field in FIG. 5, the interface may update to indicate that the “Fall applied” program is no longer being applied to the top field. While the nitrogen application in early April may remain, updates to the “Fall applied” program would not alter the April application of nitrogen.

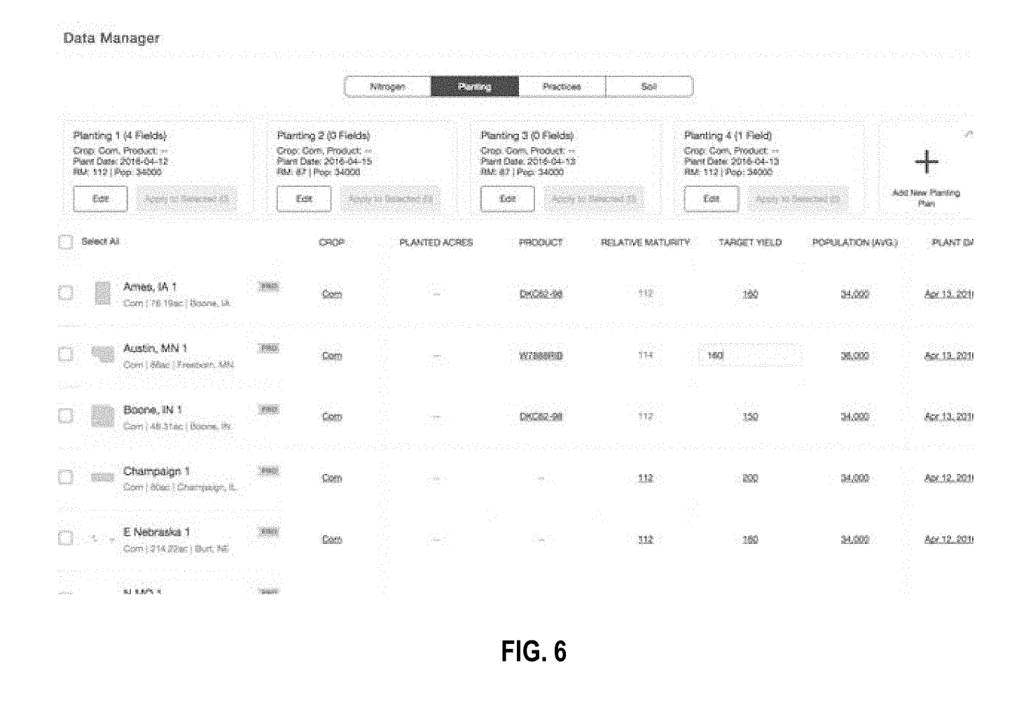

FIG. 6 depicts an example embodiment of a spreadsheet view for data entry. Using the display depicted in FIG. 6, a user can create and edit information for one or more fields. The data manager may include spreadsheets for inputting information with respect to Nitrogen, Planting, Practices, and Soil as depicted in FIG. 6. To edit a particular entry, a user computer may select the particular entry in the spreadsheet and update the values. For example, FIG. 6 depicts an in-progress update to a target yield value for the second field. Additionally, a user computer may select one or more fields in order to apply one or more programs. In response to receiving a selection of a program for a particular field, the data manager may automatically complete the entries for the particular field based on the selected program. As with the timeline view, the data manager may update the entries for each field associated with a particular program in response to receiving an update to the program. Additionally, the data manager may remove the correspondence of the selected program to the field in response to receiving an edit to one of the entries for the field.

In an embodiment, model and field data is stored in model and field data repository 160. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model data may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

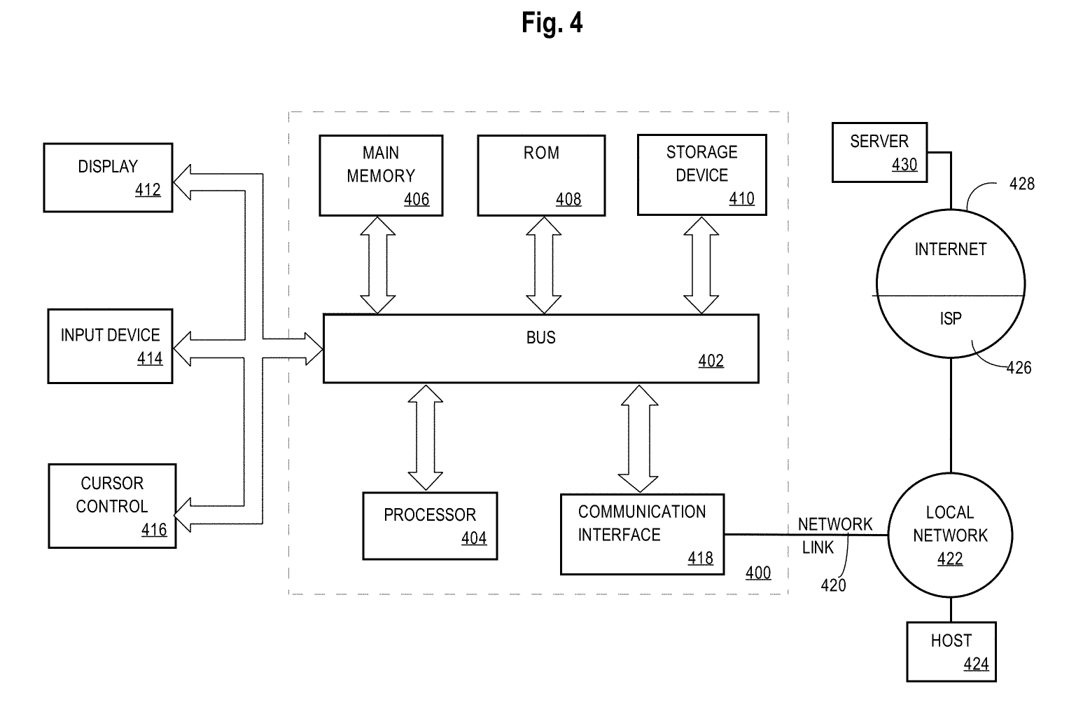

Hardware/virtualization layer 150 comprises one or more central processing units (CPUs), memory controllers, and other devices, components, or elements of a computer system such as volatile or non-volatile memory, non-volatile storage such as disk, and I/O devices or interfaces as illustrated and described, for example, in connection with FIG. 4. The layer 150 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 104 associated with different users. Further, the system 130 and/or external data server computer 108 may be implemented using two or more processors, cores, clusters, or instances of physical machines or virtual machines, configured in a discrete location or co-located with other elements in a datacenter, shared computing facility or cloud computing facility.

2.2. Application Program Overview

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for inventions and disclosures of this type.

In an embodiment, user 102 interacts with agricultural intelligence computer system 130 using field manager computing device 104 configured with an operating system and one or more application programs or apps; the field manager computing device 104 also may interoperate with the agricultural intelligence computer system independently and automatically under program control or logical control and direct user interaction is not always required. Field manager computing device 104 broadly represents one or more of a smart phone, PDA, tablet computing device, laptop computer, desktop computer, workstation, or any other computing device capable of transmitting and receiving information and performing the functions described herein. Field manager computing device 104 may communicate via a network using a mobile application stored on field manager computing device 104, and in some embodiments, the device may be coupled using a cable 113 or connector to the sensor 112 and/or controller 114. A particular user 102 may own, operate or possess and use, in connection with system 130, more than one field manager computing device 104 at a time.

The mobile application may provide client-side functionality, via the network to one or more mobile computing devices. In an example embodiment, field manager computing device 104 may access the mobile application via a web browser or a local client application or app. Field manager computing device 104 may transmit data to, and receive data from, one or more front-end servers, using web-based protocols or formats such as HTTP, XML and/or JSON, or app-specific protocols. In an example embodiment, the data may take the form of requests and user information input, such as field data, into the mobile computing device. In some embodiments, the mobile application interacts with location tracking hardware and software on field manager computing device 104 which determines the location of field manager computing device 104 using standard tracking techniques such as multilateration of radio signals, the global positioning system (GPS), Wi-Fi positioning systems, or other methods of mobile positioning. In some cases, location data or other data associated with the device 104, user 102, and/or user account(s) may be obtained by queries to an operating system of the device or by requesting an app on the device to obtain data from the operating system.

In an embodiment, field manager computing device 104 sends field data 106 to agricultural intelligence computer system 130 comprising or including, but not limited to, data values representing one or more of: a geographical location of the one or more fields, tillage information for the one or more fields, crops planted in the one or more fields, and soil data extracted from the one or more fields. Field manager computing device 104 may send field data 106 in response to user input from user 102 specifying the data values for the one or more fields. Additionally, field manager computing device 104 may automatically send field data 106 when one or more of the data values becomes available to field manager computing device 104. For example, field manager computing device 104 may be communicatively coupled to remote sensor 112 and/or application controller 114. In response to receiving data indicating that application controller 114 released water onto the one or more fields, field manager computing device 104 may send field data 106 to agricultural intelligence computer system 130 indicating that water was released on the one or more fields. Field data 106 identified in this disclosure may be input and communicated using electronic digital data that is communicated between computing devices using parameterized URLs over HTTP, or another suitable communication or messaging protocol.

A commercial example of the mobile application is CLIMATE FIELDVIEW, commercially available from The Climate Corporation, San Francisco, Calif. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

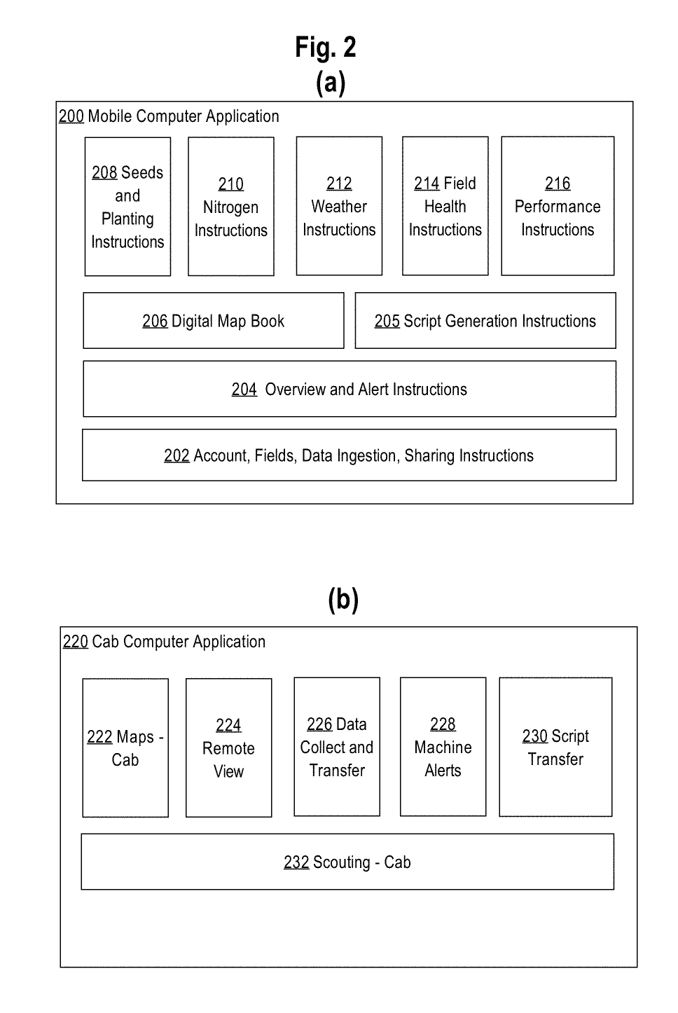

FIG. 2 illustrates two views of an example logical organization of sets of instructions in main memory when an example mobile application is loaded for execution. In FIG. 2, each named element represents a region of one or more pages of RAM or other main memory, or one or more blocks of disk storage or other non-volatile storage, and the programmed instructions within those regions. In one embodiment, in view (a), a mobile computer application 200 comprises account-fields-data ingestion-sharing instructions 202, overview and alert instructions 204, digital map book instructions 206, seeds and planting instructions 208, nitrogen instructions 210, weather instructions 212, field health instructions 214, and performance instructions 216.

In one embodiment, a mobile computer application 200 comprises account-fields-data ingestion-sharing instructions 202 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 200 comprises a data inbox. In response to receiving a selection of the data inbox, the mobile computer application 200 may display a graphical user interface for manually uploading data files and importing uploaded files to a data manager.

In one embodiment, digital map book instructions 206 comprise field map data layers stored in device memory and are programmed with data visualization tools and geospatial field notes. This provides growers with convenient information close at hand for reference, logging and visual insights into field performance. In one embodiment, overview and alert instructions 204 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 208 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 205 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 200 may display one or more fields broken into management zones, such as the field map data layers created as part of digital map book instructions 206. In one embodiment, the management zones comprise soil zones along with a panel identifying each soil zone and a soil name, texture, drainage for each zone, or other field data. Mobile computer application 200 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 200 may make the script available for download in a format readable by an application controller, such as an archived or compressed format. Additionally and/or alternatively, a script may be sent directly to cab computer 115 from mobile computer application 200 and/or uploaded to one or more data servers and stored for further use. In one embodiment, nitrogen instructions 210 are programmed to provide tools to inform nitrogen decisions by visualizing the availability of nitrogen to crops. This enables growers to maximize yield or return on investment through optimized nitrogen application during the season. Example programmed functions include displaying images such as SSURGO images to enable drawing of application zones and/or images generated from subfield soil data, such as data obtained from sensors, at a high spatial resolution (as fine as 10 meters or smaller because of their proximity to the soil); upload of existing grower-defined zones; providing an application graph and/or a map to enable tuning application(s) of nitrogen across multiple zones; output of scripts to drive machinery; tools for mass data entry and adjustment; and/or maps for data visualization, among others. “Mass data entry,” in this context, may mean entering data once and then applying the same data to multiple fields that have been defined in the system; example data may include nitrogen application data that is the same for many fields of the same grower, but such mass data entry applies to the entry of any type of field data into the mobile computer application 200. For example, nitrogen instructions 210 may be programmed to accept definitions of nitrogen planting and practices programs and to accept user input specifying to apply those programs across multiple fields. “Nitrogen planting programs,” in this context, refers to a stored, named set of data that associates: a name, color code or other identifier, one or more dates of application, types of material or product for each of the dates and amounts, method of application or incorporation such as injected or knifed in, and/or amounts or rates of application for each of the dates, crop or hybrid that is the subject of the application, among others. “Nitrogen practices programs,” in this context, refers to a stored, named set of data that associates: a practices name; a previous crop; a tillage system; a date of primarily tillage; one or more previous tillage systems that were used; one or more indicators of application type, such as manure, that were used. Nitrogen instructions 210 also may be programmed to generate and cause displaying a nitrogen graph, which indicates projections of plant use of the specified nitrogen and whether a surplus or shortfall is predicted; in some embodiments, different color indicators may signal a magnitude of surplus or magnitude of shortfall. In one embodiment, a nitrogen graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each nitrogen application and amount at points correlated to month names; and numeric and/or colored indicators of surplus or shortfall, in which color indicates magnitude.

In one embodiment, the nitrogen graph may include one or more user input features, such as dials or slider bars, to dynamically change the nitrogen planting and practices programs so that a user may optimize his nitrogen graph. The user may then use his optimized nitrogen graph and the related nitrogen planting and practices programs to implement one or more scripts, including variable rate (VR) fertility scripts. Nitrogen instructions 210 also may be programmed to generate and cause displaying a nitrogen map, which indicates projections of plant use of the specified nitrogen and whether a surplus or shortfall is predicted; in some embodiments, different color indicators may signal a magnitude of surplus or magnitude of shortfall. The nitrogen map may display projections of plant use of the specified nitrogen and whether a surplus or shortfall is predicted for different times in the past and the future (such as daily, weekly, monthly or yearly) using numeric and/or colored indicators of surplus or shortfall, in which color indicates magnitude. In one embodiment, the nitrogen map may include one or more user input features, such as dials or slider bars, to dynamically change the nitrogen planting and practices programs so that a user may optimize his nitrogen map, such as to obtain a preferred amount of surplus to shortfall. The user may then use his optimized nitrogen map and the related nitrogen planting and practices programs to implement one or more scripts, including variable rate (VR) fertility scripts. In other embodiments, similar instructions to the nitrogen instructions 210 could be used for application of other nutrients (such as phosphorus and potassium) application of pesticide, and irrigation programs.

In one embodiment, weather instructions 212 are programmed to provide field-specific recent weather data and forecasted weather information. This enables growers to save time and have an efficient integrated display with respect to daily operational decisions.

In one embodiment, field health instructions 214 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 216 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 216 may be programmed to communicate via the network(s) 109 to back-end analytics programs executed at agricultural intelligence computer system 130 and/or external data server computer 108 and configured to analyze metrics such as yield, hybrid, population, SSURGO, soil tests, or elevation, among others. Programmed reports and analysis may include yield variability analysis, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of cab computer 115. For example, referring now to view (b) of FIG. 2, in one embodiment a cab computer application 220 may comprise maps-cab instructions 222, remote view instructions 224, data collect and transfer instructions 226, machine alerts instructions 228, script transfer instructions 230, and scouting-cab instructions 232. The code base for the instructions of view (b) may be the same as for view (a) and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 222 may be programmed to provide map views of fields, farms or regions that are useful in directing machine operation. The remote view instructions 224 may be programmed to turn on, manage, and provide views of machine activity in real-time or near real-time to other computing devices connected to the system 130 via wireless networks, wired connectors or adapters, and the like. The data collect and transfer instructions 226 may be programmed to turn on, manage, and provide transfer of data collected at machine sensors and controllers to the system 130 via wireless networks, wired connectors or adapters, and the like. The machine alerts instructions 228 may be programmed to detect issues with operations of the machine or tools that are associated with the cab and generate operator alerts. The script transfer instructions 230 may be configured to transfer in scripts of instructions that are configured to direct machine operations or the collection of data. The scouting-cab instructions 230 may be programmed to display location-based alerts and information received from the system 130 based on the location of the agricultural apparatus 111 or sensors 112 in the field and ingest, manage, and provide transfer of location-based scouting observations to the system 130 based on the location of the agricultural apparatus 111 or sensors 112 in the field.

2.3. Data Ingest to the Computer System

In an embodiment, external data server computer 108 stores external data 110, including soil data representing soil composition for the one or more fields and weather data representing temperature and precipitation on the one or more fields. The weather data may include past and present weather data as well as forecasts for future weather data. In an embodiment, external data server computer 108 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil.

In an embodiment, remote sensor 112 comprises one or more sensors that are programmed or configured to produce one or more observations. Remote sensor 112 may be aerial sensors, such as satellites, vehicle sensors, planting equipment sensors, tillage sensors, fertilizer or insecticide application sensors, harvester sensors, and any other implement capable of receiving data from the one or more fields. In an embodiment, application controller 114 is programmed or configured to receive instructions from agricultural intelligence computer system 130. Application controller 114 may also be programmed or configured to control an operating parameter of an agricultural vehicle or implement. For example, an application controller may be programmed or configured to control an operating parameter of a vehicle, such as a tractor, planting equipment, tillage equipment, fertilizer or insecticide equipment, harvester equipment, or other farm implements such as a water valve. Other embodiments may use any combination of sensors and controllers, of which the following are merely selected examples.

The system 130 may obtain or ingest data under user 102 control, on a mass basis from a large number of growers who have contributed data to a shared database system. This form of obtaining data may be termed “manual data ingest” as one or more user-controlled computer operations are requested or triggered to obtain data for use by the system 130. As an example, the CLIMATE FIELDVIEW application, commercially available from The Climate Corporation, San Francisco, Calif., may be operated to export data to system 130 for storing in the repository 160.

For example, seed monitor systems can both control planter apparatus components and obtain planting data, including signals from seed sensors via a signal harness that comprises a CAN backbone and point-to-point connections for registration and/or diagnostics. Seed monitor systems can be programmed or configured to display seed spacing, population and other information to the user via the cab computer 115 or other devices within the system 130. Examples are disclosed in U.S. Pat. No. 8,738,243 and US Pat. Pub. 20150094916, and the present disclosure assumes knowledge of those other patent disclosures.

Likewise, yield monitor systems may contain yield sensors for harvester apparatus that send yield measurement data to the cab computer 115 or other devices within the system 130. Yield monitor systems may utilize one or more remote sensors 112 to obtain grain moisture measurements in a combine or other harvester and transmit these measurements to the user via the cab computer 115 or other devices within the system 130.

In an embodiment, examples of sensors 112 that may be used with any moving vehicle or apparatus of the type described elsewhere herein include kinematic sensors and position sensors. Kinematic sensors may comprise any of speed sensors such as radar or wheel speed sensors, accelerometers, or gyros. Position sensors may comprise GPS receivers or transceivers, or Wi-Fi-based position or mapping apps that are programmed to determine location based upon nearby Wi-Fi hotspots, among others.

In an embodiment, examples of sensors 112 that may be used with tractors or other moving vehicles include engine speed sensors, fuel consumption sensors, area counters or distance counters that interact with GPS or radar signals, PTO (power take-off) speed sensors, tractor hydraulics sensors configured to detect hydraulics parameters such as pressure or flow, and/or and hydraulic pump speed, wheel speed sensors or wheel slippage sensors. In an embodiment, examples of controllers 114 that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors 112 that may be used with seed planting equipment such as planters, drills, or air seeders include seed sensors, which may be optical, electromagnetic, or impact sensors; downforce sensors such as load pins, load cells, pressure sensors; soil property sensors such as reflectivity sensors, moisture sensors, electrical conductivity sensors, optical residue sensors, or temperature sensors; component operating criteria sensors such as planting depth sensors, downforce cylinder pressure sensors, seed disc speed sensors, seed drive motor encoders, seed conveyor system speed sensors, or vacuum level sensors; or pesticide application sensors such as optical or other electromagnetic sensors, or impact sensors. In an embodiment, examples of controllers 114 that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors 112 that may be used with tillage equipment include position sensors for tools such as shanks or discs; tool position sensors for such tools that are configured to detect depth, gang angle, or lateral spacing; downforce sensors; or draft force sensors. In an embodiment, examples of controllers 114 that may be used with tillage equipment include downforce controllers or tool position controllers, such as controllers configured to control tool depth, gang angle, or lateral spacing.

In an embodiment, examples of sensors 112 that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors such as accelerometers disposed on sprayer booms. In an embodiment, examples of controllers 114 that may be used with such apparatus include pump speed controllers; valve controllers that are programmed to control pressure, flow, direction, PWM and the like; or position actuators, such as for boom height, subsoiler depth, or boom position.

In an embodiment, examples of sensors 112 that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers 114 that may be used with harvesters include header operating criteria controllers for elements such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors 112 that may be used with grain carts include weight sensors, or sensors for auger position, operation, or speed. In an embodiment, examples of controllers 114 that may be used with grain carts include controllers for auger position, operation, or speed.

In an embodiment, examples of sensors 112 and controllers 114 may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser. No. 14/831,165 and the present disclosure assumes knowledge of that other patent disclosure.

In an embodiment, sensors 112 and controllers 114 may be affixed to soil sampling and measurement apparatus that is configured or programmed to sample soil and perform soil chemistry tests, soil moisture tests, and other tests pertaining to soil. For example, the apparatus disclosed in U.S. Pat. No. 8,767,194 and U.S. Pat. No. 8,712,148 may be used, and the present disclosure assumes knowledge of those patent disclosures.

In another embodiment, sensors 112 and controllers 114 may comprise weather devices for monitoring weather conditions of fields. For example, the apparatus disclosed in International Pat. Application No. PCT/US2016/029609 may be used, and the present disclosure assumes knowledge of those patent disclosures.

2.4 Process Overview-Agronomic Model Training

In an embodiment, the agricultural intelligence computer system 130 is programmed or configured to create an agronomic model. In this context, an agronomic model is a data structure in memory of the agricultural intelligence computer system 130 that comprises field data 106, such as identification data and harvest data for one or more fields. The agronomic model may also comprise calculated agronomic properties which describe either conditions which may affect the growth of one or more crops on a field, or properties of the one or more crops, or both. Additionally, an agronomic model may comprise recommendations based on agronomic factors such as crop recommendations, irrigation recommendations, planting recommendations, and harvesting recommendations. The agronomic factors may also be used to estimate one or more crop related results, such as agronomic yield. The agronomic yield of a crop is an estimate of quantity of the crop that is produced, or in some examples the revenue or profit obtained from the produced crop.

In an embodiment, the agricultural intelligence computer system 130 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location or an estimate of nitrogen content with a soil sample measurement.

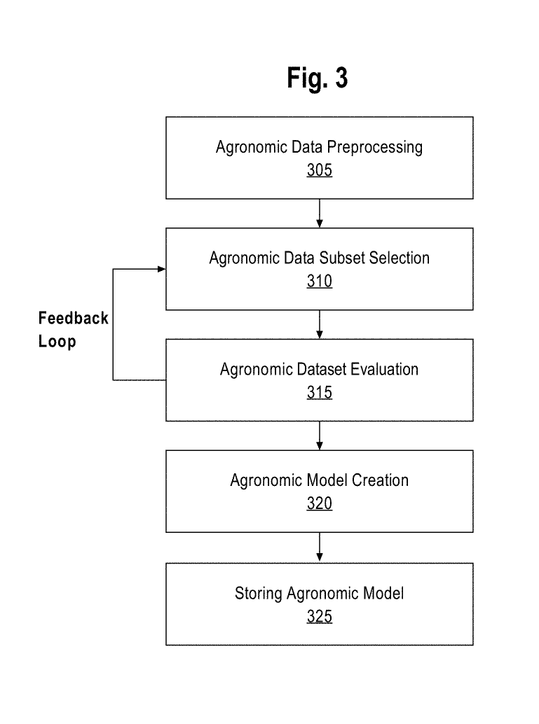

FIG. 3 illustrates a programmed process by which the agricultural intelligence computer system generates one or more preconfigured agronomic models using field data provided by one or more data sources. FIG. 3 may serve as an algorithm or instructions for programming the functional elements of the agricultural intelligence computer system 130 to perform the operations that are now described.

At block 305, the agricultural intelligence computer system 130 is configured or programmed to implement agronomic data preprocessing of field data received from one or more data sources. The field data received from one or more data sources may be preprocessed for the purpose of removing noise and distorting effects within the agronomic data including measured outliers that would bias received field data values. Embodiments of agronomic data preprocessing may include, but are not limited to, removing data values commonly associated with outlier data values, specific measured data points that are known to unnecessarily skew other data values, data smoothing techniques used to remove or reduce additive or multiplicative effects from noise, and other filtering or data derivation techniques used to provide clear distinctions between positive and negative data inputs.

At block 310, the agricultural intelligence computer system 130 is configured or programmed to perform data subset selection using the preprocessed field data in order to identify datasets useful for initial agronomic model generation. The agricultural intelligence computer system 130 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 315, the agricultural intelligence computer system 130 is configured or programmed to implement field dataset evaluation. In an embodiment, a specific field dataset is evaluated by creating an agronomic model and using specific quality thresholds for the created agronomic model. Agronomic models may be compared using cross validation techniques including, but not limited to, root mean square error of leave-one-out cross validation (RMSECV), mean absolute error, and mean percentage error. For example, RMSECV can cross validate agronomic models by comparing predicted agronomic property values created by the agronomic model against historical agronomic property values collected and analyzed. In an embodiment, the agronomic dataset evaluation logic is used as a feedback loop where agronomic datasets that do not meet configured quality thresholds are used during future data subset selection steps (block 310).

At block 320, the agricultural intelligence computer system 130 is configured or programmed to implement agronomic model creation based upon the cross validated agronomic datasets. In an embodiment, agronomic model creation may implement multivariate regression techniques to create preconfigured agronomic data models.

At block 325, the agricultural intelligence computer system 130 is configured or programmed to store the preconfigured agronomic data models for future field data evaluation.

2.5 Implementation Example—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 3. Persistent Properties of an Agricultural Field

In an embodiment, intra-field yield variations for an agricultural field are determined based on persistent characteristics of the field. The persistent characteristics may include soil characteristics and topographical characteristics of the field.

Information about persistent characteristics of a field may be obtained from different data sources. For example, the data may be obtained from data repositories maintained by Research Partners (RP), governmental agencies, crop growers, and other sources. Examples of data sets may include the Integrated Farming Systems 2014 Research Partner dataset, the National Elevation dataset, the Monsanto Light Detection and Ranging dataset, the Soil Survey Geographic Database, satellite maps, and other maps and data records.

For purposes of illustrating clear examples, various means, terminology and mathematical equations that are customary for persons of ordinary skill in the art to which this disclosure pertains are used in part of the description. The nature of the disclosure is that improvements in this field are expressed functionally, and in mathematical terms, in the customary communications between people of skill in the art. Each mathematical equation or expression that is described herein is intended to represent all or part of a computational algorithm that can be implemented using a computer, and is intended to be implemented using technical means, such as a programmed computer, software application, firmware, hardware logic or a combination thereof and the disclosure is directed to improved technical means for carrying out the functions that are described herein.

3.1 Soil Attributes Data

In an embodiment, digital data representing soil attributes are determined from physical soil samples. Soil sampling may be performed within individual sample areas in a certain grid that is determined for an agricultural field. The grid may be specified in many ways. For example, a field may be divided into a grid in which each grid element includes an area that has 2.5 acres and separate samples may be taken at field locations within each grid element.

In an embodiment, for each soil sample, digital data is generated or collected for: organic matter (OM, in percentage), cation exchange capacity (CEC, in meq/100), soil pH, buffer pH (BpH), phosphorus (P, in ppm), potassium (K, in ppm), calcium (Ca, in ppm), and magnesium (Mg, in ppm). The obtained sample values may be interpolated to the ⅓ arc second grids. The interpolation may be performed by either ordinary kriging or bi-cubic interpolation method. Selection of the interpolation method usually depends on the number of soil samples.

In an embodiment, soil attributes obtained from a soil sample include an organic matter percentage, cation exchange capacity information, buffer pH value, pH value, phosphorus parts per million, potassium parts per million, potassium parts per million, magnesium parts per million, and calcium parts per million. Other attributes may also be obtained and used to determine intra-field yield variations data.

Soil attributes for a field may be obtained from digital data sources that are separate from the computers that are programmed to analyze field variability as detailed herein. Examples of such sources include the US General Soils Map (STATSG02), the Soil Survey Geographic Database (SSURGO), and the National Resources Inventory (NRI) soil maps. The soils maps include soil characteristics and soil attributes for agricultural fields. The soil maps datasets are usually publicly available.

SSURGO data usually uses graphical maps to depict patterns in the distribution of soil components across a field. The soil component distribution may be identified in a map with key values, and a unique key may be associated with a unique soil component. In the dataset, the distribution may be represented using spatial polygon shapes, and may be spatially joined with the gridded data. Additional component identifications may include map unit Soil Keys (mukey) and Symbol (musym), and may be included to represent a shape of the distribution.

In an embodiment, SSURGO data includes a horizon thickness representative, OM representative, K-saturation representative, AWC representative, and CEC pH₇ representative. These attributes provide additional information about the soil that can be used in determining intra-field yield variations data.

In an embodiment, one or more survey maps are obtained and used as a source of information about persistent attributes of soil of an agricultural field. The maps may include survey maps, satellite maps, and other types of maps. The maps may be processed to determine boundaries in the field that delineate regions having soil properties varying within the field. The boundaries also indicate where soil properties change by more than a certain predetermined threshold.

3.2 Topographical Features Data

In an embodiment, topographical features data for an agricultural field comprises elevation data, and elevation-related data, for the field. Collectively, this digital data can be used to develop a three-dimensional profile of a field or at least visualize high and low points within the field. The topographical features data may be obtained from maps, satellite maps, and the like. Some topographical data may be received for example, from an elevation raster. An elevation raster may be a combination of the National Elevation Dataset (NED) and Monsanto Light Detection and Ranging (LIDAR) Dataset. The resolution in which the topographical details are depicted in the maps may vary from location to location. If various resources containing topographical data for the same location are available, then the resource with the most detailed data for the location may be used.

In an embodiment, elevation features may include physical elevation information, compound topographic index information, water flow accumulation information, water flow direction information, slope percentage information, and curvature information.

The amount of topographical details per area may vary and may depend on whether the area is rural. For example, topographical details for rural areas may be scarce, while topographical details for non-rural areas may be available in greater quantity and detail.

In addition to elevation data for a field, topographical attributes may include a Compound Topographic Index (CTI), also referred to as Topographic Wetness Index. CTI is a steady-state wetness index for the field and is strongly correlated to soil moisture.

In an embodiment, topographical attributes include a depiction of a flow direction of a water flow in a map. A flow direction determines into which neighboring pixel of for example, a digital map any water in a central pixel will flow naturally. This attribute is particularly useful in hydrology analysis.

In an embodiment, topographical attributes include flow accumulation data, which can be used to find a drainage pattern of a terrain. Topographical attributes may also include a curvature, which is a measure that describes the amount by which a field deviates from being flat. In the context of the topology of the field, a curvature is a measure of hilliness of the field. Topographical attributes may also include a slope percentage. A slope percentage is determined as a maximum rate of change in elevation within in a field. For example, a slope percentage may indicate a maximum rate of change in elevation from one sub-field to the neighboring sub-field of the field.

### 4. Data Preprocessing and Filtering

Persistent attributes data for an agricultural field that is received from RPs and/or governmental agencies is usually filtered and/or preprocessed to some degree. However, since the data may be provided from different sources, in different formats and for overlapping time periods, further data filtering and/or preprocessing may be recommended. The recommended filtering/preprocessing is usually performed to improve the data quality, and may include a removal of redundant data records, outliers and anomalies.

In an embodiment, upon receiving persistent attributes data for a field, a test is performed to determine whether the received data includes outliers. If the received data includes outliers, then the data records that are suspected of including the outliers are either removed or flagged. The data cleaning process may be performed using for example software-based editors. Some of the editors may be configured with a graphical user interface (GUI) which allows locating and removing the outliers from the data sets in an efficient way.

Filtering and preprocessing of persistent attributes data can be performed either sequentially or in parallel. For example, in some situations, filtering may be performed first and preprocessing second. In other situations preprocessing may be performed first, and filtering second. In other situations both the filtering and preprocessing are performed simultaneously, or only one of them is performed.

4.1 Filtering of Persistent Properties Data

In an embodiment, persistent properties data for a field is filtered. The filtering may include removing, from the persistent attributes data, those data records that appear to be incorrect or unsuitable for determining intra-field yield variations for the field. The criteria for determining such data records may be chosen based on a training set of data or a visual inspection of the received data. The criteria may also depend on the source from which the data is received and the format in which the received data is provided.

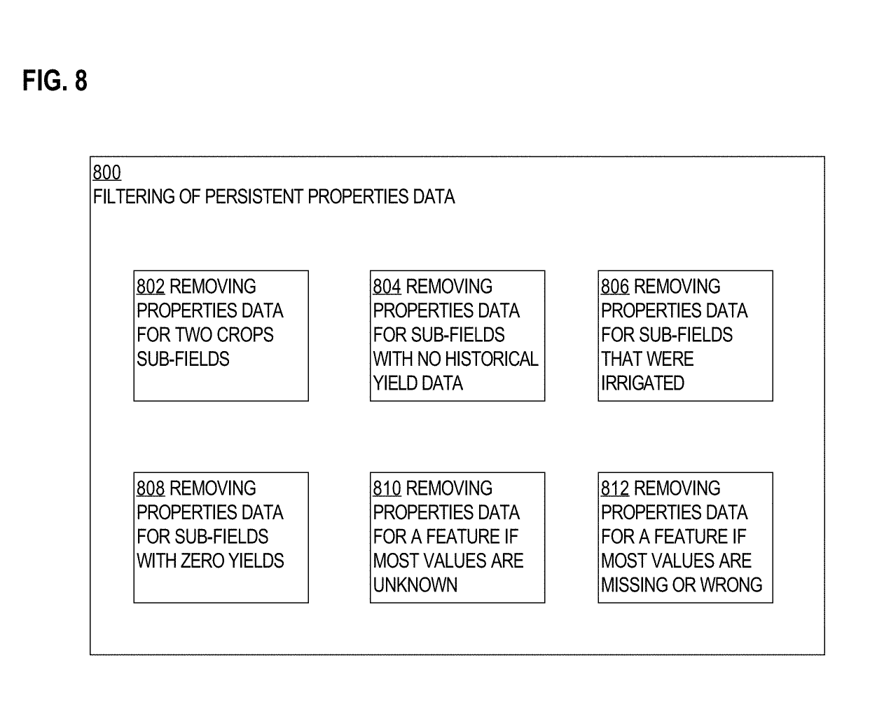

FIG. 8 depicts an example embodiment of filtering persistent properties data. The depicted types of a filtering of the persistent properties data are provided to illustrate clear examples; however, they are not to be viewed as an exhaustive list of possible types of data filtering.

Examples of various types of filtering that may be performed on persistent properties data for a field may include removing, from a set of persistent properties data, the data records that correspond to a sub-field on which two crops were grown 802. The examples may also include removing the data records for which historical yield data is unavailable 804, the data records for sub-fields that were irrigated 806, the data records for sub-fields with zero yields 808, the data records for a feature if most values are unknown 810, and the data records for which values are missing or incorrect 812.

4.2 Preprocessing of Persistent Properties Data

Datasets containing persistent properties data for an agricultural field are often incomplete. For example, a dataset may have no values for certain attributes for certain fields or sub-fields. One solution to this problem is to determine values that are missing in the datasets by interpolating the values using the values that are available in the datasets. Usually, the values may be interpolated by either an ordinary kriging or a bi-cubic interpolation. The selection of the interpolation method typically depends on the count of data points in a soil sample. For example, assuming a threshold to be 35 data points, if a soil sample includes more than 35 points, then the ordinary kriging may be used; otherwise, the bi-cubic interpolation is recommended.
4.2.1 Spatial Interpolation of Soil Attributes Data

Interpolation is one type of data preprocessing, and generally refers to a process of estimating unknown data point values in a dataset. Usually, the more known data point values are available, the more accurate interpolation of the unknown data point values may be. Another factor that impacts the accuracy of the interpolation is the spatial arrangements of the known data points within the set: the better spread of the known data points in the dataset, the more accurate interpolation of the unknown data point values may be.

Global interpolators usually use all available data points in a dataset to provide estimates for the points with unknown values. In contrast, local interpolators use only the information in the vicinity of the data point that is being estimated.

Kriging is a particular type of a local interpolator that uses more advanced geostatistical techniques. Kriging usually produces better estimates of unknown data points than other interpolations methods because kriging takes an explicit account of the effects of random noise. Furthermore, kriging is less susceptive than other methods to arbitrary decisions such as determining a search distance, or a location of break points.

In situations when a size of soil samples is small, the quality of the interpolated data might be unsatisfactory. That in turn may cause generating inter-field yield variations data that is inaccurate or ambiguous. This problem may be solved by using for example, the sub-field boundary information from the SSURGO maps to augment the soil sample data before the data is used to generate the inter-field yield variations performance information.
4.2.2 Correlating Persistent Features

A dataset containing persistent attributes data for an agricultural field may include many features that are either redundant or irrelevant. These features may often be removed from the dataset without diminishing the value of the dataset. By removing such features, the dataset may become smaller, and the process of determining inter-field yield variations may be executed faster and more efficiently. Removing such features from a dataset is referred to as preprocessing. Preprocessing may also include determining the non-redundant features that cannot be removed from a dataset.

In an embodiment, a dataset containing persistent attributes data is preprocessed by determining non-redundant features in the dataset. This may be performed using a correlation feature selection approach.

A correlation feature selection approach uses a correlation feature selection measure. The measure evaluates subsets of features by determining a set of features that are highly correlated with a particular classification, yet uncorrelated to each other.

Examples of soil attributes are included in the table below:

TABLE 1
Examples of soil attributes and abbreviations
used for the soil attributes

| | Name | Abbreviation |
|---|---|---|
| Elevation raster | Elevation | Elevation |
| | Compound Topographic Index | CTI |
| | Flow Accumulation | Flow_Accum |
| | Flow Direction | Flow_Dir |
| | Slope Percentage | Slope_Per |
| | Curvature | Curvature |
| Soil Sample | Organic Matter Percentage | OM_pct |
| | Cation Exchange Capacity | CEC |
| | Buffer pH | BpH |
| | pH | pH |
| | Phosphorus Parts Per Million | P_ppm |
| | Potassium Parts Per Million | K_ppm |
| | Magnesium Parts Per Million | Mg_ppm |
| | Calcium Parts Per Million | Ca_ppm |
| SSURGO | Horizon Thickness Representative | hzthk_r |
| | OM Representative | om_r |
| | K Saturation Representative | ksat_r |
| | AWC Representative | awc_r |
| | CEC pH 7 Representative | cec7_r |

In a typical persistent attributes dataset, examples of highly correlated features may include OM_pct and CEC because OM_pct and CEC exhibit very similar spatial patterns. This may be because OM_pct and CEC are affected by the same underlying factors. Other examples of highly correlated features include awc_r, cec7_r, om_r and ksat_r, CEC, Ca_ppm, Mg_ppm, om_r and cec7_r, CTI and Flow_Accum.

In an embodiment, datasets containing persistent features data for a field are processed to identify, in the datasets, one or more highly correlated features. The identified highly correlated features are used to explain intra-field yield variations data for the field. Intra-field yield variations data may be determined based on absolute yield performance data determined for an agricultural field. For example, the intra-field yield variations data may be generated by converting the absolute yield data to relative yield computed for neighboring sub-fields within a field.

### 5. Determining Intra-Field Yield Variations Based on Properties of an Agricultural Field

Intra-field yield variations for a field may be determined based on both persistent properties and transient features such as weather. Before the approach for determining intra-field yield variations based solely on the persistent properties data is described, a general formula for determining intra-field yield variations based on both types of features is provided below.

Let Y represent the relative yield performance for a field in a given year. Let X represent the persistent features such as soil and topographic properties. Let W represent the transient features such as weather. For a given location, X can be considered as deterministic and fixed, but the transient features W may vary with time. Therefore, W may be treated as a random variable. With this notation, Y may be expressed in terms of W and X as follows:

Y=ƒ(X,W)+ϵ, (1)

where ƒ is a real function and epsilon represents a random error. Expression (1) provides a very general representation of how persistent and transient features impact the crop yield.

Assume further that a mean value for c is zero. Under this setting, the relative yield performance in different years, Y1, . . . , Yt can be treated as different realizations of expression (1).

A linear regression Y that represents the relative yield performance for a field in a given year may be expressed as

Y=Xα+Wβ+ϵ, (2)

where Y and W are the sample average, and ̂α, ̂β are the Minimum Likelihood Estimates (MLE) of α and β respectively.

If the W component, representing transient features such as weather, is ignored, and only persistent attributes values for the field are considered, then expression (2) provides a mathematical description of the relations between the persistent attributes values for the field and estimated inter-field yield variations determined using an estimator. Example estimators are described below. Expression (2) is a base expression used by the estimator instructions or programming described below.

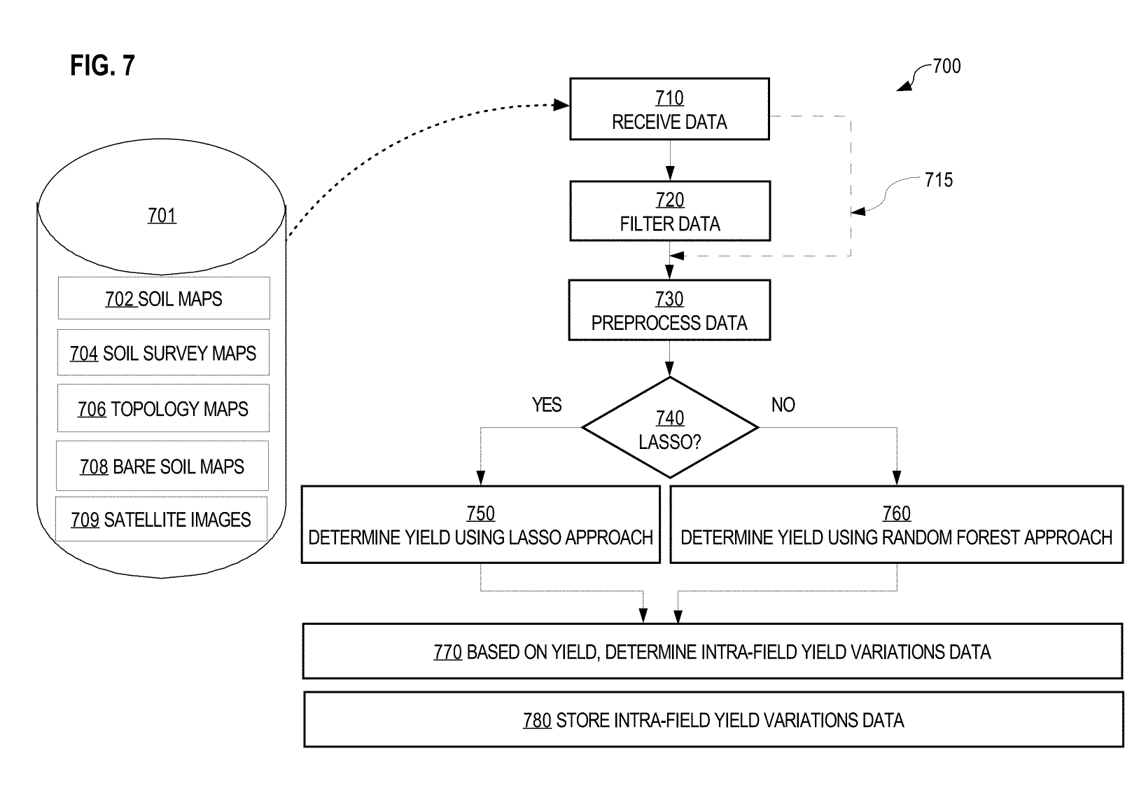

FIG. 7 is a flow diagram that depicts an example method or algorithm for determining intra-field yield variations based on persistent properties data for an agricultural field.

In step 710, persistent properties data for an agricultural field are received. Persistent properties data may be received from any of various sources, including server computers and databases 701, cloud storage systems, data service providers, external data storage devices, and the like. Persistent properties data received at step 710 may include soil maps 702, soil survey maps 704, topology maps 706, bare soil maps 708, satellite images 709, and any other information pertaining to the persistent characteristics of the soil and field.

In step 720, the persistent properties data received at step 710 is filtered. Filtering of the persistent properties data is described further herein in connection with FIG. 8. Examples of different types of filtering that may be performed on the persistent properties data include removing data records that correspond to sub-fields on which two or more crops were grown, records for which historical yield data is unavailable, records for sub-fields that were irrigated, the data records for sub-fields with zero yields, records for an attribute if most values are unknown, and records for a feature if most values are missing or incorrect.

In step 730, the persistent properties data is preprocessed. Preprocessing is usually performed to improve the data quality, and may include a removal of redundant data records, outliers and anomalies. Persistent attributes data for an agricultural field that is received from RPs and/or governmental agencies is usually filtered and/or preprocessed as the data may be provided from different sources, in different formats and for overlapping time periods.

Persistent properties data that is subjected to preprocessing in this step may include filtered data, unfiltered data, or a combination of both filtered and unfiltered data. In some implementations, preprocessing is an alternative to filtering at step 720 and the selection between using the filtering and preprocessing depends on the type and quality of the received data. The order of filtering versus preprocessing may vary and one or the other may be omitted.

In step 740, the process tests whether a least absolute shrinkage and selection operator (LASSO) approach is to be used to estimate yield data for the agricultural field. The test of step 740 will be true if the LASSO approach has been implemented in the computer system that is executing the process and negative if not; thus step 740 is an availability test for whether LASSO logic is present. If the LASSO approach is implemented, then control passes to step 750 and otherwise control transfers to step 760.

In step 750, estimated yield data for an agricultural field is determined using the LASSO operator. In an embodiment, the LASSO operator is applied to the preprocessed data representing persistent attributes of the agricultural field. Application of the LASSO operator to the preprocessed information causes generating based on, at least in part, the preprocessed information, estimate absolute yield performance data for the agricultural field. The LASSO operator is described in detail in the following sections.

In step 760, an approach other than the LASSO approach is used to determine predicted yield data for an agricultural field. An example of the applicable approach, other than the LASSO approach, is a random forest (RF) approach. The RF approach is described in detail in the following sections.

In step 770, intra-field yield variations data is generated based on absolute yield performance data determined for an agricultural field. This step may also be performed in the LASSO approach. In an embodiment, the intra-field yield variations data is generated by converting the absolute yield data to relative yield computed for the neighboring sub-fields within the field. The conversion may be performed using the NQT transformation described below. The intra-field yield variations data is also referred to as relative yield performance data.

One of the benefits of converting absolute yield performance data to intra-field yield variations data is that the intra-field yield variations reveal the reoccurring spatial yield patterns within a field better than the absolute yield data. Furthermore, the intra-field yield variations data enables using yield records of different crops without a barrier. Using the intra-field yield variations data is also more resilient to outliers which are commonly present in the absolute yield data. In addition, the relative yield performance data provides more information about the field and the sub-fields than the absolute yield data.

In an embodiment, absolute yield performance data is transformed to intra-field yield variations data using the NQT transformation. The NQT transformation allows assessing whether a set of absolute yield data items is approximately normally distributed. If it is, then the distribution of the observations could be graphically represented using a straight line. A straight line may indicate that that there is no variation in the yield distribution from one sub-field to another sub-field. However, if the yield data for the sub-fields of the field is not normally distributed, then the yield distribution varies from one sub-field to another sub-field. The variations may be captured and referred to as the intra-field yield variations for the field.

In an embodiment, the NQT approach includes ordering the absolute yield data determined for an agricultural field from the smallest value to the largest value to form an ordered set of absolute yield data. Values of the ordered set may be plotted against the corresponding quantiles (10^{th} percentile) from the standard normal distribution, or other normal distribution, to obtain a plot of sample quantiles along one axis and theoretical quantiles along another axis of a two-dimensional plot. If the largest value from the ordered set of absolute yield data is larger than it is expected from the sample plot under normality, then the tail distribution of the values in the set indicates a non-normal distributions of the values in the set. On the other hand, if the smallest value from the ordered set of absolute yield data is larger than it is expected from the sample plot under normality, then the tail distribution of the values in the set indicates a non-normal distribution of the values in the set. The non-normal distribution of the values in the set may indicate variations in the inter-field yield values for the field.

In step 780, information about intra-field yield variations for a field is stored in a storage device. The stored information may be made available to users, crop growers, researches and others.

The stored information may also be ported to a computer system that manages certain agronomic practices such as seeding, irrigation, nitrogen application, and/or harvesting.

In an embodiment, information about intra-field yield variations is provided to the users and displayed in a GUI generated on display devices of workstations, laptops, PDAs, or mobile devices. The information about the intra-field yield variations may be presented to a user in form of color-shaded maps, graphs, and others graphical displays. The information may be also presented to a user in form of a chart, a data table, and the like.

5.1 Determining Yield Variations Using Lasso Approach

The LASSO approach is a regression method that involves penalizing an absolute size of regression coefficients. The penalizing is equivalent to constraining the sum of the absolute values of the model parameter estimates. By penalizing the sum of the absolute values, some of the parameter estimates may reach a zero value. Hence, applying a large penalty may cause shrinking the further estimates toward zero.

In an embodiment, yield variations for an agricultural field are estimated using the LASSO approach applied to persistent attributes data provided for the field. In this approach, values of some coefficients are purposefully reduced (shrunk) and values of some other coefficients are purposefully set to 0. Reducing, and in some cases even eliminating, some of the coefficients allows retaining certain attributes for both subset selection and ridge regression.

The LASSO approach is an estimation method applicable to datasets having linear properties. The LASSO approach is designed to minimize the residual sum of squares subject to the sum of the absolute values of the coefficients that are smaller than a constant. While the ordinary least square (OLS) estimator minimizes the residual sum of squares, the LASSO estimator minimizes the residual sum of squares subject to the sum of the absolute values of the coefficients smaller than a constant. Determining the absolute values of such coefficients and computing their sum is one of the constraints of the LASSO approach. Due to the nature of the constraint, the LASSO approach tends to produce some coefficients that are exactly zero, and this may lead to obtaining a smaller subset of variables for the model. Although the method gives a biased estimation of the parameter, the prediction might have a smaller root mean square error (RMSE) compared to for example, the OLS estimator.

In an embodiment, the LASSO approach is implemented to predict yield in an agricultural field. An implementation of the LASSO approach to predicting yield may include the following assumptions: let Y represent the relative yield performance for a field in a given year; let X represent the persistent features, such as soil and topographic properties. Then, assuming that the model is linear, Y may be represented as:

Y=Xβ+ϵ, (3)

where β is the p×1 vector of coefficients, and p is the number of features involved in the model (including the intercept). The LASSO approach allows minimizing the estimate β by calculating:

$${min}_{β} {‖ Y - B β ‖}_{2}^{2} + λ {‖ β ‖}_{1} , \qquad ( 4 )$$

where λ is the penalized parameter.

In an embodiment, cross-validation within the training dataset may be used for finding λ to obtain the best prediction performance.

In an embodiment, values of Y, which represent the relative yield performance for a field in a given year, are used as intra-field yield variations for the field. Application of the LASSO estimator to the persistent attributes data for the field allows determining the intra-field yield variations for the field.

5.2 Determining Yield Variations Using Random Forest Approach

In an embodiment, a Random Forest (RF) approach may be used as a learning method with the benefit that it can incorporate nonlinearity and between-variable interactions, and may be implemented based on a training sample set of persistent attributes data. As one example, a training sample set may be represented as:

$$S = [ \begin{matrix}{f}_{A 1} & {f}_{B 1} & {f}_{C 1} & {C}_{1} \\ ⋮ & & ⋮ & \\ {f}_{AN} & {f}_{BN} & {f}_{CN} & {C}_{N}\end{matrix} ] \qquad ( 5 )$$

where f_{A1} represents a feature A of the first sample, f_{B1} represents a feature B of the first sample, f_{C1} represents a feature C of the first sample, f_{AN} represents a feature A of the N-th sample, f_{BN} represents a feature B of the N-th sample, f_{CN} represents a feature C of the N-th sample, C₁ is a first training class, and C_{N} is a N-th training class.

Based on the training sample set S, a plurality of random subsets is created. Each of the random subset may have a randomly selected subset of the features selected from the training sample.

In an embodiment, a plurality of random subsets may be created for example, by determining:

$${S}_{1} = [ \begin{matrix}{f}_{A 12} & {f}_{B 12} & {f}_{C 12} & {C}_{12} \\ {f}_{A 15} & {f}_{B 15} & {f}_{C 15} & {C}_{15} \\ ⋮ & & ⋮ & \\ {f}_{A 35} & {f}_{B 35} & {f}_{C 35} & {C}_{35}\end{matrix} ] {S}_{2} = [ \begin{matrix}{f}_{A 2} & {f}_{B 2} & {f}_{C 2} & {C}_{2} \\ {f}_{A 6} & {f}_{B 6} & {f}_{C 6} & {C}_{6} \\ ⋮ & & ⋮ & \\ {f}_{A 20} & {f}_{B 20} & {f}_{C 20} & {C}_{20}\end{matrix} ] \\ {S}_{M} = [ \begin{matrix}{f}_{A 4} & {f}_{B 4} & {f}_{C 4} & {C}_{4} \\ {f}_{A 9} & {f}_{B 9} & {f}_{C 9} & {C}_{9} \\ ⋮ & & ⋮ & \\ {f}_{A 12} & {f}_{B 12} & {f}_{C 12} & {C}_{12}\end{matrix} ] \qquad ( 6 )$$

In this example, based on the S1 random subset, a first decision tree may be created. Based on the S2 random subset, a second decision tree may be created. Based on the SM random subset, an M^{th} decision tree may be created. Creating a plurality of decision trees leads to creating a “forest” of the decision trees.

In an embodiment, a plurality of decision trees is used to determine a ranking of classifiers. For example, based on four decision trees, we may derive four classes that may be used to make decisions for particular values of certain features. Each of the four decision trees is used to determine votes for making a decision for a particular value of a certain feature. Hence, the difficulty in this process is creating the decision trees. Once the decision trees are created, the decisions with respect to certain features may be easily made.

### 6. Benefits and Extensions

Information about intra-field yield variations for an agricultural field is often critical in optimizing agronomic practices for the field. For example, based on the intra-field yield variations, a crop grower may optimize amounts of fertilizer to be applied to the field, selections of seeds, or timing for seed planting. This type of optimization may in turn contribute to increased efficiency in use of resources.

Information about intra-field yield variations across sub-fields of an agricultural field may be used to automatically control a computer system that manages certain agronomic practices such as seeding, irrigation, nitrogen application, and/or harvesting. For example, the intra-field yield variations across the sub-fields may be used to determine recommendations for seeding requirements for each individual sub-field.

Another benefit of the presented approach is that intra-field yield variations for an agricultural field are determined based solely on soil properties and the field's elevation information, and without any information about historical yield data for the field. This is mainly because the persistent property data for a field does not change frequently and is rather easily available, while historical yield data is not always available.

Furthermore, the approach allows determining recurring spatial yield patterns inside the field solely on the soil properties and elevation information.

Using information about soil and topographical features of a field in addition to using for example, historical yield records, has a potential to improve and enhance the accuracy of spatial yield patterns. For example, in some situations, the information about certain types of the persistent characteristics of the soil and/or certain types of persistent topographical features of the field may help to enhance the accuracy of predicted yield performance from the field.

Intra-field yield performance data generated based on persistent characteristics of a field can be used to generate a plot of relative yield for an agricultural field. One of the benefits of generating such a plot is that the plot allows identifying sub-fields with consistent yield patterns and sub-fields with inconsistent yield patterns. Such a plot, in comparison with a plot generated based on the historical yield data, allows the computer to refine delineation of the yield patterns across the field.

Since soil and topographical properties are often considered time-invariant within a certain time period, and do not take into account time-dependent factors such as weather, yield patterns and variations generated based on the soil and topographical properties data may represent weather-independent predictions of the yield. Such yield patterns may also be referred to as yield patterns that could be expected if the weather and other time-dependent factors cooperate within a given year.

An approach for determining intra-field yield variations based on persistent attributes data for an agricultural field is particularly applicable to predict yield performance from certain types of fields. Such fields include fields that exhibit strong correlation between the persistent features and the yield patterns. It is recommended to determine whether a field exhibits such a correlation before giving deference to the intra-field yield performance data obtained based on solely the persistent attributes data.

What is claimed is:

1. A method comprising:
using instructions programmed in a computer system comprising one or more processors and computer memory:
receiving permanent properties data for a plurality of agricultural sub-fields of an agricultural field;
determining whether at least one data item is missing for any sub-field of the plurality of agricultural sub-fields of the agricultural field in the permanent properties data;
in response to determining that at least one data item is missing for any sub-field of the plurality of agricultural sub-fields of the agricultural field in the permanent properties data, generating, based on, at least in part, the permanent properties data, additional properties data for the plurality of agricultural sub-fields that includes the at least one data item;
wherein a data item, of the at least one data item, is generated by interpolating and aggregating two or more data records in the permanent properties data;
generating preprocessed permanent properties data by merging the permanent properties data with the additional properties data;
based on, at least in part, the preprocessed permanent properties data, generating filtered permanent properties data by removing, from the preprocessed permanent properties data, a set of preprocessed permanent properties records corresponding to a subset of the plurality of agricultural sub-fields in which two or more crops were grown in the same year;
applying a regression operator to the filtered permanent properties data to determine a plurality of intra-field variations values that represent intra-field variations in predicted yield of crop harvested from the plurality of agricultural sub-fields;
storing the intra-field variations values in the computer memory.

2. The method of claim 1, further comprising: applying a least absolute shrinkage and selection operator (LASSO) to the filtered permanent properties data to determine the plurality of intra-field variations values that represent the intra-field variations in the predicted yield of crop harvested from the plurality of agricultural sub-fields.

3. The method of claim 1, further comprising: applying a random forest (RF) operator to the filtered permanent properties data to determine the plurality of intra-field variations values that represent the intra-field variations in the predicted yield of crop harvested from the plurality of agricultural sub-fields.

4. The method of claim 1, further comprising: based on, at least in part, the plurality of intra-field variations values, determining a plurality of yield patterns of the predicted yield of crop harvested from the plurality of agricultural sub-fields, and storing the plurality of yield patterns in the computer memory.

5. The method of claim 1, further comprising: using the plurality of intra-field variations values that represent intra-field variations in the predicted yield of crop harvested from the plurality of agricultural sub-fields to automatically control a computer control system to manage one or more of: seeding, irrigation, nitrogen application, or harvesting.

6. The method of claim 1, wherein the permanent properties data for the plurality of agricultural sub-fields comprises one or more of: soil property data, soil survey maps, topographical properties data, bare soil maps, or satellite images; wherein the soil property data comprises soil measurement data; wherein the topographical properties data comprises elevation data and elevation associated properties data.

7. The method of claim 1, further comprising: identifying a particular type of a subset of the permanent properties data; based on, at least in part, on the particular type of the permanent properties data, determining a second plurality of intra-field variations values that represent second intra-field variations in the predicted yield of crop harvested from the plurality of agricultural sub-fields for the particular type of properties data.

8. The method of claim 1, further comprising: determining whether the at least one data item is missing for a particular sub-field of the plurality of agricultural sub-fields of the agricultural field due to of one or more of: historical data for the particular sub-field is unavailable, the particular sub-field is irrigated, or no crop was harvested from the particular sub-field.

9. A data processing system comprising:
a computer memory;
one or more processors coupled to the computer memory and programmed to:
receiving permanent properties data for a plurality of agricultural sub-fields of an agricultural field;
determining whether at least one data item is missing for any sub-field of the plurality of agricultural sub-fields of the agricultural field in the permanent properties data;
in response to determining that at least one data item is missing for any sub-field of the plurality of agricultural sub-fields of the agricultural field in the permanent properties data, generating, based on, at least in part, the permanent properties data, additional properties data for the plurality of agricultural sub-fields that includes the at least one data item;
wherein a data item, of the at least one data item, is generated by interpolating and aggregating two or more data records in the permanent properties data;
generating preprocessed permanent properties data by merging the permanent properties data with the additional properties data;
based on, at least in part, the preprocessed permanent properties data, generating filtered permanent properties data by removing, from the preprocessed permanent properties data, a set of preprocessed permanent properties records corresponding to a subset of the plurality of agricultural sub-fields in which two or more crops were grown in the same year;
applying a regression operator to the filtered permanent properties data to determine a plurality of intra-field variations values that represent intra-field variations in predicted yield of crop harvested from the plurality of agricultural sub-fields;
storing the intra-field variations values in the computer memory.

10. The data processing system of claim 9, wherein the one or more processors are further programmed to perform: applying a least absolute shrinkage and selection operator (LASSO) to the filtered permanent properties data to determine the plurality of intra-field variations values that represent the intra-field variations in the predicted yield of crop harvested from the plurality of agricultural sub-fields.

11. The data processing system of claim 9, wherein the one or more processors are further programmed to perform: applying a random forest (RF) operator to the filtered permanent properties data to determine the plurality of intra-field variations values that represent the intra-field variations in the predicted yield of crop harvested from the plurality of agricultural sub-fields.

12. The data processing system of claim 9, wherein the one or more processors are further programmed to perform: based on, at least in part, the plurality of intra-field variations values, determining a plurality of yield patterns of the predicted yield of crop harvested from the plurality of agricultural sub-fields, and storing the plurality of yield patterns in the computer memory.

13. The data processing system of claim 9, wherein the one or more processors are further programmed to perform: using the plurality of intra-field variations values that represent intra-field variations in the predicted yield of crop harvested from the plurality of agricultural sub-fields to automatically control a computer control system to manage one or more of: seeding, irrigation, nitrogen application, or harvesting.

14. The data processing system of claim 9, wherein the permanent properties data for the plurality of agricultural sub-fields comprises one or more of: soil property data, soil survey maps, topographical properties data, bare soil maps, or satellite images; wherein the soil property data comprises soil measurement data; wherein the topographical properties data comprises elevation data and elevation associated properties data.

15. The data processing system of claim 9, wherein the one or more processors are further programmed to perform: identifying a particular type of a subset of the permanent properties data; based on, at least in part, on the particular type of the permanent properties data, determining a second plurality of intra-field variations values that represent second intra-field variations in the predicted yield of crop harvested from the plurality of agricultural sub-fields for the particular type of properties data.

16. The data processing system of claim 9, wherein the one or more processors are further programmed to perform: determining whether the at least one data item is missing for a particular sub-field of the plurality of agricultural sub-fields of the agricultural field due to of one or more of: historical data for the particular sub-field is unavailable, the particular sub-field is irrigated, or no crop was harvested from the particular sub-field.

17. One or more non-transitory computer-readable storage media storing one or more computer instructions which, when executed by one or more processors, cause the processors to perform:
receiving permanent properties data for a plurality of agricultural sub-fields of an agricultural field;
determining whether at least one data item is missing for any sub-field of the plurality of agricultural sub-fields of the agricultural field in the permanent properties data;
in response to determining that at least one data item is missing for any sub-field of the plurality of agricultural sub-fields of the agricultural field in the permanent properties data, generating, based on, at least in part, the permanent properties data, additional properties data for the plurality of agricultural sub-fields that includes the at least one data item;
wherein a data item, of the at least one data item, is generated by interpolating and aggregating two or more data records in the permanent properties data;
generating preprocessed permanent properties data by merging the permanent properties data with the additional properties data;
based on, at least in part, the preprocessed permanent properties data, generating filtered permanent properties data by removing, from the preprocessed permanent properties data, a set of preprocessed permanent properties records corresponding to a subset of the plurality of agricultural sub-fields in which two or more crops were grown in the same year;
applying a regression operator to the filtered permanent properties data to determine a plurality of intra-field variations values that represent intra-field variations in predicted yield of crop harvested from the plurality of agricultural sub-fields;
storing the intra-field variations values in a computer memory.

18. The one or more non-transitory computer-readable storage media of claim 17, storing additional instructions for: applying a least absolute shrinkage and selection operator (LASSO) to the filtered permanent properties data to determine the plurality of intra-field variations values that represent the intra-field variations in the predicted yield of crop harvested from the plurality of agricultural sub-fields.

19. The one or more non-transitory computer-readable storage media of claim 17, storing additional instructions for: applying a random forest (RF) operator to the filtered permanent properties data to determine the plurality of intra-field variations values that represent the intra-field variations in the predicted yield of crop harvested from the plurality of agricultural sub-fields.

20. The one or more non-transitory computer-readable storage media of claim 17, storing additional instructions for: based on, at least in part, the plurality of intra-field variations values, determining a plurality of yield patterns of the predicted yield of crop harvested from the plurality of agricultural sub-fields, and storing the plurality of yield patterns in the computer memory.
